(19) United States
(12) Patent Application Publication
(10) Pub. No.: US 2014/0240283 A1
(43) Pub. Date: Aug. 28, 2014

(54) PROTECTING PHYSICAL SIGNAL PATHS USING CAPACITIVE SENSING TECHNIQUES

(71) Applicant: CIRQUE CORPORATION, Salt Lake City, UT (US)

(72) Inventor: Keith L. Paulsen, Centerville, UT (US)

(73) Assignee: CIRQUE CORPORATION, Salt Lake City, UT (US)

(21) Appl. No.: 14/191,723

(22) Filed: Feb. 27, 2014

Related U.S. Application Data
(60) Provisional application No. 61/770,181, filed on Feb. 27, 2013.

(51) Int. Cl. G06F 3/044

(52) U.S. Cl. CPC G06F 3/044
USPC 345/174

(57) ABSTRACT

A system and method for detecting the presence of a probe on or near an electrode that may transmit secure data by detecting a change in capacitance on the electrode, and wherein action may be taken to stop transmission on the electrode if a probe is detected.

### BACKGROUND OF THE INVENTION

1. Field of the Invention

This invention relates generally to touch sensors and secure digital communication pathways between components in a touch sensor that enable the secure entry of data to a touch sensor.

2. Description of Related Art

There are several designs for capacitance sensitive touch sensors. It is useful to examine the underlying technology to better understand how a capacitance sensitive touchpad may be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24.

Although the CIRQUE® touchpad described above uses a grid of X and Y electrodes 12, 14 and a separate and single sense electrode 16, the sense electrode can actually be the X or Y electrodes 12, 14 by using multiplexing.

### BRIEF SUMMARY OF THE INVENTION

In a preferred embodiment, the present invention is a system and method for detecting the presence of a probe on or near an electrode that may transmit secure data by detecting a change in capacitance on the electrode, and wherein action may be taken to stop transmission on the electrode if a probe is detected.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

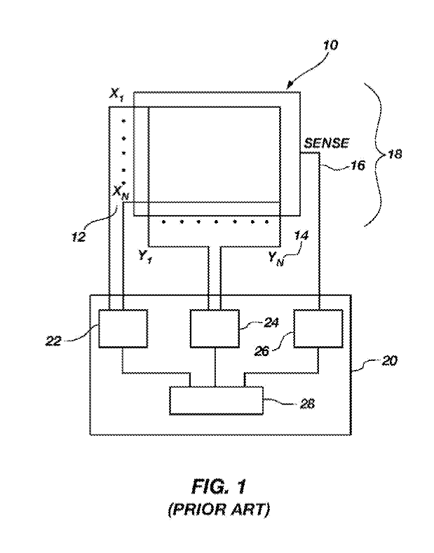

FIG. 2 is a diagram of a circuit that transmits data from one component to another over a plurality of electrodes, and a touch sensor circuit coupled to the plurality of electrodes for detecting changes in capacitance.

FIG. 3 is diagram showing the presence of a probe making contact with one of the plurality of electrodes that is transmitting data.

FIG. 4 is a flowchart that identifies the method of the first embodiment of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document includes any capacitive touch sensor device, including touchpads, touch screens and touch panels, and includes proximity and touch sensing capabilities.

Previous technology for securing a touch sensor is directed to the concept of protecting an operating volume. An operating volume may be defined as a space within which a touch sensor and its components such as touch sensing circuitry are disposed. Thus, an operating volume may be a housing of a point-of-sale (POS) terminal. A touch sensor and its touch sensing circuitry may be disposed within the POS terminal. Electrodes may be disposed around the inside of the POS terminal in order to sense the volume within the POS terminal. If there are changes that are detectable by capacitance sensitive circuitry within the POS terminal, then the detectable changes may cause a system to react to the changes. For example, the system may be able to prevent the interception of data when a probe is penetrating the POS terminal in order to insert an electrode for intercepting communication. The communication may be between the touch sensor and any other circuitry with which the touch sensor communicates.

The present invention may be directed to the concept of providing increased security for digital communications by focusing detecting efforts on individual communication lines. These communication lines may belong to any component, and not just to the touch sensor. The present invention may be directed to detection of a probe that is in proximity of or making direct contact with an electrode that functions as a communication line, wherein the probe may attempt to intercept signals on the electrode that is carrying information. The electrode may transmit data between two integrated circuits. The integrated circuits may provide any function. The electrode should not be considered as limited between two integrated circuits, and may carry any analog or digital signals.

A first embodiment of the present invention may be directed to the detection of a probe that is approaching any electrode that provides communication of data. It may be assumed that the probe may cause a change in capacitance on the electrode. The change in capacitance may be caused by proximity of the probe to the electrode or by direct contact on the electrode by the probe.

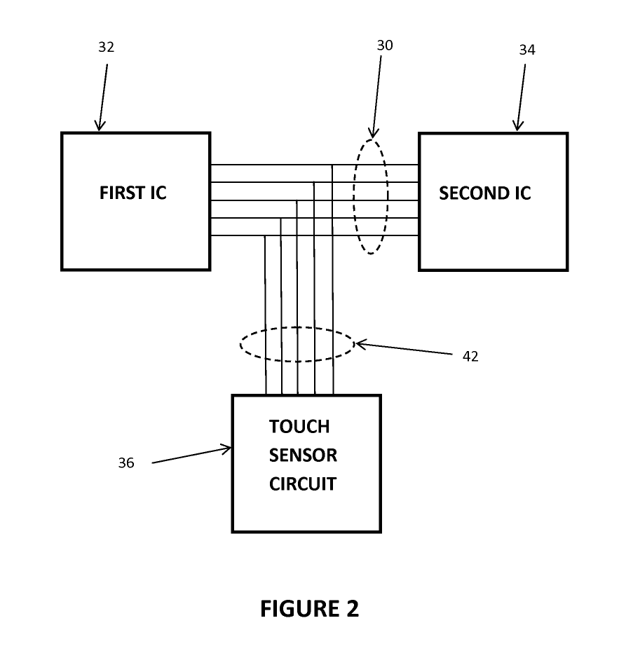

FIG. 2 shows a plurality of electrodes 30 that are electrically coupled to a first integrated circuit 32 and a second integrated circuit 34. It may be assumed that the plurality of electrodes 30 carry data between the first and the second integrated circuits 32, 34, or only from one to the other. What is important is that the plurality of electrodes 30 may be transmitting analog and/or digital data that needs to be securely transmitted. It does not matter what data they are transmitting, or what components the data is transmitted between. The number of electrodes 30 may also vary and is not a limiting aspect of the invention.

FIG. 2 shows that each of the plurality of electrodes 30 is coupled to a touch sensor circuit 36 by a plurality of monitoring electrodes 42. The touch sensor circuit 36 may be capable of sensing very small changes in capacitance on the plurality of electrodes 30 by measuring changes in capacitance of the monitoring electrodes 42. The monitoring electrodes 42 may be in physical contact or they may be in electrical proximity. Being in electrical proximity is defined in this document as being near enough to sense changes in capacitance.

The touch sensor circuit 36 may be dedicated to the function of security as in the first embodiment, or it may also function in association with a touch sensor (not shown) so as to also perform touch sensor functions. The touch sensor circuit 36 may be capable of detecting changes in capacitance on the order of femtofarads or smaller.

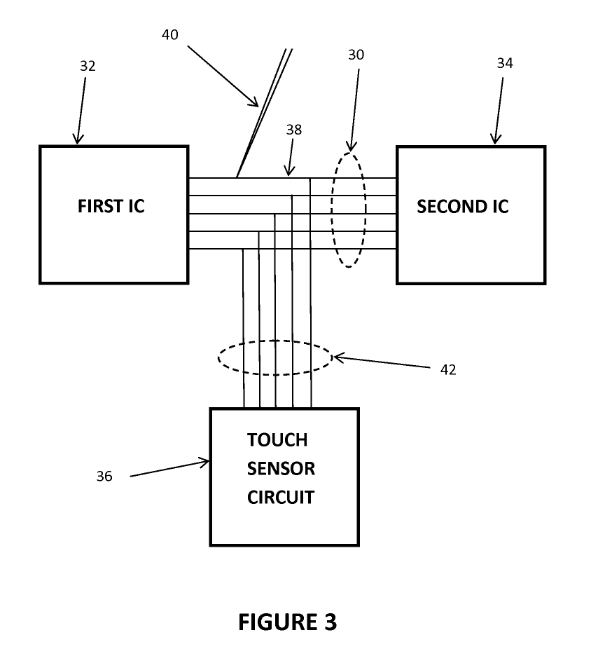

FIG. 3 shows a probe 40 that is in contact with one of the plurality of electrodes being monitored 30. The probe 40 may cause a decrease or an increase in capacitance on the electrode 38 that is being touched. The touch sensor circuit 36 may detect this change in capacitance using one or more of the plurality of monitoring electrodes 42.

After probe detection, the system of the first embodiment may take one of several different actions. These actions may be directed by the touch sensor circuit 36 or some other component that includes a microprocessor or a state machine. For this example, it may be assumed that the touch sensor circuit 36 includes some processing capabilities and is directing the actions to be performed if the probe 40 is detected.

First, the touch sensor circuit 36 may be capable of transmitting a signal to alert or warn another device or component of the presence of the probe 40. Second, the touch sensor circuit 36 may be capable of terminating the transmission of data on the plurality of electrodes 30 to thereby prevent interception of data. Third, the touch sensor circuit 36 may transmit a signal to another device that stops transmission of the data on the plurality of electrodes 30. What is important is that the transmission of data be terminated so that no more data may be intercepted.

The present invention may be capable of detecting the presence of the probe 40 on or near a single electrode that may transmit data, or on a plurality of different electrodes.

One application of the present invention may be in a financial transaction. A user may be required to enter a personal identification number (PIN) on a touch screen of a POS terminal. The PIN data may have to be transmitted from the touch screen in order to confirm the PIN data. The touch screen may include a touch sensor circuit that may be required to transmit the data to another component within the POS terminal in order to verify PIN data. Payment industry standards require protecting PIN data from being accessible by a probe that may try to capture signals from the touch screen. In some cases the integrated circuits and electrodes for connecting a touch controller IC (touch sensor circuit) and microprocessor are housed in a Tamper Resistant Security Module. However, the present invention now provides an additional layer of security. It should be understood that the data electrode that may be monitored may carry unsecure data or secure data.

The present invention may now monitor electrodes transmitting digital communication signals by periodically measuring current paths including the dielectric between the electrodes being protected and other nearby electrodes that may be strategically placed to sense changes in material such as etching, chipping or adding conductive inks, etc. The present invention may be used to detect any leakage of current or change in bulk capacitance of the protected electrodes.

The present invention may also be used to monitor other traces not necessarily associated with the touch IC communications such as to protect contact card connector and electrodes from probing or insertion of a man-in-the-middle device left in the contact card socket.

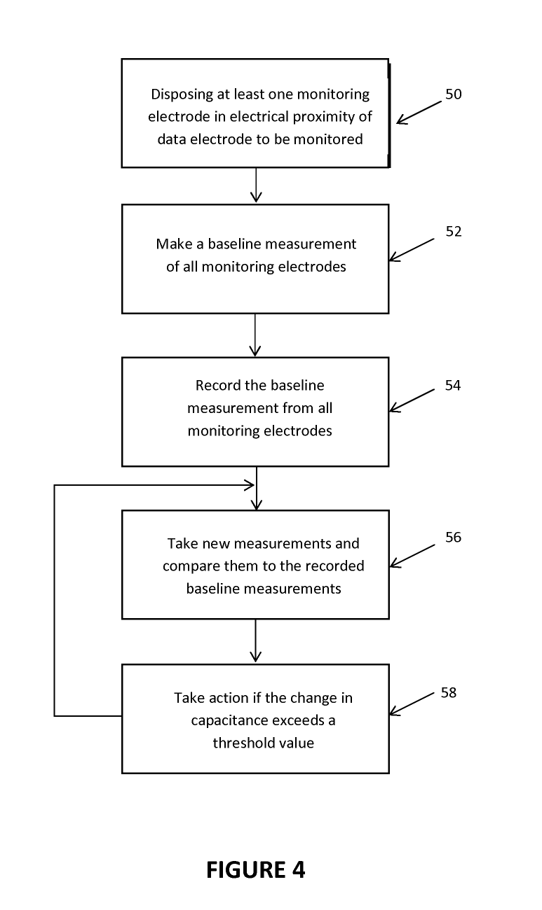

FIG. 4 is provided as a flowchart that identifies the method of the first embodiment of the present invention. Therefore, the first embodiment may be used to protect data electrodes from probing by following the steps of disposing at least one monitoring electrode that is in electrical proximity to the data electrodes to be monitored in item 50. This means that the at least one monitoring electrode may be touching the data electrode to be monitored, or at least close enough to be in electrical proximity.

For example, the monitoring electrode may be disposed between two or more data electrodes to be monitored. There may also be a plurality of monitoring electrodes that are disposed in electrical proximity to a plurality of different data electrodes to be monitored.

The next step in item 52 is to make a capacitance measurement such as bulk capacitance of the data electrodes and capacitance between the data electrodes and other nearby data electrodes. This baseline measurement or measurements may be for a single monitoring electrode or for a plurality of monitoring electrodes that are in contact with or in electrical proximity of the data electrodes.

Once the baseline measurements have been made, the next step in item 54 is to record the baseline measurement or measurements that were made in the previous step. It is necessary to record the baseline measurements so that whenever new measurements are made, they may be compared with the baseline measurements that are stored somewhere in memory, such as in the touch sensor circuit 36.

The next step in item 56 is to continuously take new measurements and compare them with the baseline measurements that have been recorded. These new measurements may be made with either end of the data electrodes by driving high, driving low or being tri-stated, etc., as understood by those skilled in the art.

The final step is to take some action if a new measurement is different enough from a recorded baseline measurement. The decision to take action may be based upon a threshold value in the measured change in capacitance between the at least one monitoring electrode and the at least one data electrode. The specific threshold value for determining that action may be taken may be programmable and changeable.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for determining if there is a change in capacitance on at least one data electrode performing data transmission, said method comprised of:
providing at least one data electrode used for transmitting data, providing at least one monitoring electrode that is disposed in electrical proximity of the at least one data electrode, and providing a touch sensor circuit capable of detecting changes in capacitance on the at least one data electrode;
taking a baseline measurement of the capacitance on the at least one monitoring electrode and recording the baseline measurement;
taking a new measurement of capacitance on the at least one monitoring electrode;
comparing the new measurement to the baseline measurement to determine if a change in capacitance can be detected on the at least one monitoring electrode; and
performing an action on the at least one data electrode if the change in capacitance exceeds a threshold value.

2. The method as defined in claim 1 wherein the method further comprises terminating transmission of data on the at least one data electrode if the change in capacitance exceeds the threshold value.

3. The method as defined in claim 2 wherein the method further comprises making the threshold value for the change in capacitance a value that may be changed as desired in order to change sensitivity to changes in capacitance as measured by the at least one monitoring electrode.

4. The method as defined in claim 3 wherein the method further comprises providing a touch sensor that is coupled to the touch sensor circuit such that the touch sensor circuit can also enable the touch sensor to function.

5. The method as defined in claim 1 wherein the method further comprises selecting the at least one data electrode from the group of data electrodes comprised of unsecure data electrodes and secure data electrodes.

6. The method as defined in claim 1 wherein the method further comprises disposing the at least one monitoring electrode in physical contact with the at least one data electrode.

7. The method as defined in claim 1 wherein the method further comprises disposing the at least one monitoring electrode so that it is not in direct physical contact with the at least one data electrode.

8. A system for determining if a probe is causing a change in capacitance on at least one data electrode performing data transmission, said system comprised of:
at least one data electrode used for transmitting data;
at least one monitoring electrode that is disposed in electrical proximity of the at least one data electrode; and
a touch sensor circuit capable of detecting changes in capacitance on the at least one data electrode that are caused by a probe, and for transmitting a signal indicating the presence of the probe in electrical proximity of or in direct contact with the at least one data electrode.

9. The system as defined in claim 8 wherein the system further comprises a switch for terminating transmission of data on the at least one data electrode if the change in capacitance exceeds the threshold value.

10. The system as defined in claim 8 wherein the system further comprises a memory circuit for storing the threshold value for the change in capacitance a value that may be changed as desired in order to change sensitivity to changes in capacitance as measured by the at least one monitoring electrode.

11. The system as defined in claim 8 wherein the system further comprises a touch sensor that is coupled to the touch sensor circuit such that the touch sensor circuit can also enable the touch sensor to function.

12. The system as defined in claim 1 wherein the system further comprises selecting the at least one data electrode from the group of data electrodes comprised of unsecure data electrodes and secure data electrodes.

13. The system as defined in claim 1 wherein the system further comprises the at least one monitoring electrode being disposed in direct physical contact with the at least one data electrode.

14. The system as defined in claim 1 wherein the system further comprises the at least one monitoring electrode being disposed so that it is not in direct physical contact with the at least one data electrode.

15. A method for determining if there is a change in capacitance on at least one data electrode performing data transmission, said method comprised of:
providing at least one data electrode used for transmitting data, providing at least one monitoring electrode that is disposed in electrical proximity of the at least one data electrode, and providing a touch sensor circuit that is coupled to the at least one monitoring electrode and which is capable of detecting changes in capacitance on the at least one data electrode;
taking a baseline measurement of the capacitance on the at least one monitoring electrode and recording the baseline measurement;
taking a new measurement of capacitance on the at least one monitoring electrode;
comparing the new measurement to the baseline measurement to determine if a change in capacitance can be detected on the at least one monitoring electrode which indicates a change in capacitance on the at least one data electrode; and
performing an action on the at least one data electrode if the change in capacitance exceeds a threshold value.

16. A method for determining if a probe is causing a change in capacitance on at least one data electrode performing data transmission, said method comprised of:
providing at least one data electrode used for transmitting data, providing at least one monitoring electrode that is disposed in electrical proximity of the at least one data electrode, and providing a touch sensor circuit that is coupled to the at least one monitoring electrode and which is capable of detecting changes in capacitance on the at least one data electrode;
detecting a change in capacitance on the at least one data electrode by measuring the capacitance on the at least one monitoring electrode; and
terminating data transmission on the at least one data electrode if the change in capacitance exceeds a threshold value.
